(19) United States
(12) Patent Application Publication
(10) Pub. No.: US 2002/0140282 A1
(43) Pub. Date: Oct. 3, 2002

(54) Tractor trailer air brakes

(76) Inventor: Jack Costa, Mississauga (CA)

Correspondence Address: ELIAS C. BORGES, BORGES BANASINSKI ROLLE LLP, 10 KINGSBRIDGE GARDEN CIRCLE, SUITE 704, MISSISSAUGA, ON, L5R 3K6, CA

(21) Appl. No.: 10/106,126

(22) Filed: Mar. 22, 2002

(30) Foreign Application Priority Data
Mar. 28, 2001 (CA) 2,324,998

(51) Int. Cl. B60T 13/00

(52) U.S. Cl. 303/7; 188/170

(57) ABSTRACT

An improved air brake system for tractor trailers is disclosed. The present system immediately engages the trailer brakes of a tractor trailer when an emergency brake control member is engaged by the driver. The trailer brake is operatively coupled to a spring brake having a first spring operatively coupled to the trailer brake, the first spring engaging the trailer brake when the spring is in a relaxed position. The spring brake also has a first pneumatic chamber having a first movable diaphragm, the movable diaphragm causing the first spring to compress and disengage the brake when the first chamber is compressed with air supplied by an air line. Decompression of the first pneumatic chamber permitting the first spring to relax. The present invention comprises an electrically operated exhaust valve mounted adjacent the spring brake and operatively coupled to the first pneumatic chamber, the electrically operated exhaust valve having an exhaust state wherein the valve exhausts the first pneumatic chamber and an open state wherein the valve does not exhaust the first pneumatic chamber. The exhaust valve is operatively coupled to a control circuit which is adapted to place the exhaust valve in its exhaust state when the brake control member is operated.

### FIELD OF THE INVENTION

The invention relates generally to field of tractor trailer air brakes.

### BACKGROUND OF THE INVENTION

Jack-knifing of tractor trailers is a serious problem. Jack-knifing occurs when the truck portion of a tractor trailer is forced out of alignment with the trailer, usually as a result of hard breaking. Generally speaking, jack-knifing occurs when the truck portion of the tractor trailer begins to slow down rapidly compared to the trailer portion. The momentum of the trailer portion forces the truck out of alignment with the trailer. When jack-knifing occurs, the truck operator effectively loses control of the vehicle and an accident may result. Unfortunately, jack-knifing is most likely to occur in emergency situations when the truck brakes are applied forcefully.

Existing tractor trailer brakes are not designed to effectively prevent jack-knifing. Existing tractor trailer brakes consist of a series of pneumatically operated brakes operatively coupled to the rear wheels of the trailer. These pneumatically operated brakes are in turn operatively coupled to an air supply located in the truck via a pneumatic line. A trailer brake control valve in the truck controls the flow of air to the pneumatic brakes in the trailer, and is used to either engage or release the brakes as desired. When the operator engages the brake hand valve, pneumatic pressure travels down the pneumatic line to the pneumatic brakes causing the brakes to engage. Since the pneumatic brakes are some distance from the trailer brake control valve, there is a time delay between the activation of the trailer brake control valve and the engaging of the trailer brakes. Since the brakes in the truck portion of the tractor trailer are closer to the brake control systems than the brakes of the trailer portion are to the trailer brake control valve, the truck brakes will engage before the rear trailer brakes. In a majority of cases, this time delay is not significant; however, in emergency situations, under conditions of hard braking, this time delay may be sufficient to cause jack-knifing. Brake control systems on the market today do not address the time lag between the engaging of truck brakes and rear trailer brakes; therefore, the problem of jack-knifing tractor trailers continues.

### SUMMARY OF THE INVENTION

In accordance with the present invention, there is provided an improved air brake system for immediately engaging the trailer brake of a tractor trailer when an emergency brake control member is engaged. The trailer brake is operatively coupled to a spring brake having a first spring operatively coupled to the trailer brake, the first spring engaging the trailer brake when the spring is in a relaxed position. The spring brake also has a first pneumatic chamber having a first movable diaphragm, the movable diaphragm causing the first spring to compress and disengage the brake when the first chamber is compressed with air supplied by an air line. Decompression of the first pneumatic chamber permitting the first spring to relax. The present invention comprises an electrically operated exhaust valve mounted adjacent the spring brake and operatively coupled to the first pneumatic chamber, the electrically operated exhaust valve having an exhaust state wherein the valve exhausts the first pneumatic chamber and an open state wherein the valve does not exhaust the first pneumatic chamber. The exhaust valve is operatively coupled to a control circuit which is adapted to place the exhaust valve in its exhaust state when the brake control member is operated.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a schematic view of the brake control system of the present invention.

FIG. 2. is a cross sectional view of a trailer air brake showing the brake at normal operation.

FIG. 3 is a cross sectional view of a trailer air brake showing the brake under pneumatic parking.

FIG. 4 is a cross sectional view of the a trailer air brake showing the brake under spring applied barking.

FIG. 5 is a cross sectional view of the solenoid exhaust valve of the present invention in its exhaust position.

FIG. 6 is a cross sectional view of the solenoid exhaust valve of the present invention in its running position.

FIG. 7 is a schematic representation of the control circuit of the present invention.

In the drawings like characters of reference indicate corresponding parts in the different figures.

### DETAILED DESCRIPTION OF THE INVENTION

Before discussing the detailed operation of the present invention, an explanation of standard brakes as used on a majority of trailers must first be discussed. A majority of trailers presently on the road have a conventional friction brake operatively coupled to each trailer wheel. The friction brake, hereafter referred to as the trailer brake, is in turn operatively coupled to a spring brake. The spring brake is a pneumatically operated device which uses a flow of high pressure air from the tractor to operate the trailer brake. The present invention utilizes a majority of the features of existing spring brake systems.

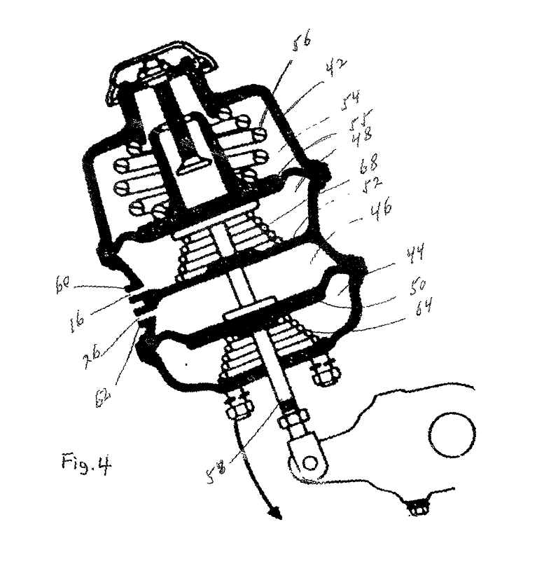

Referring to FIG. 4, a standard spring brake is shown generally as item 40 and consists of a housing 42 divided into four separate chambers, namely chamber 54, first air chamber 48, second air chamber 46, and chamber 44. Spring brake 40 also has first diaphragm 55 separating chamber 54 from first air chamber 48, metallic wall 52 separating the first and second air chambers, second diaphragm 50 separating second air chamber 46 from chamber 44, springs 56, 68 and 64 and linkage rod 58 which operatively couples spring 56 to the trailer brake. First air chamber 48 is air tight and has port 60 connected to first air supply line 16. Second chamber 46 is also air tight and has port 62 connected to second air supply line 26. Diaphragms 50 and 55 move back and forth depending on the level of air pressure in air chambers 46 and 48.

When the vehicle is parked and no air pressure is applied via lines 16 and 26, air chambers 46 and 48 are at atmospheric pressure and diaphragms 50 and 55 are in their deflated positions as shown in FIG. 4. When diaphragms 50 and 55 are in their deflated positions, spring 56 is relaxed and pushes rod 58 until it engages the trailer brakes. The pressure which can be applied by spring 56 is suitable to engage the trailer brakes with sufficient force to keep the trailer parked.

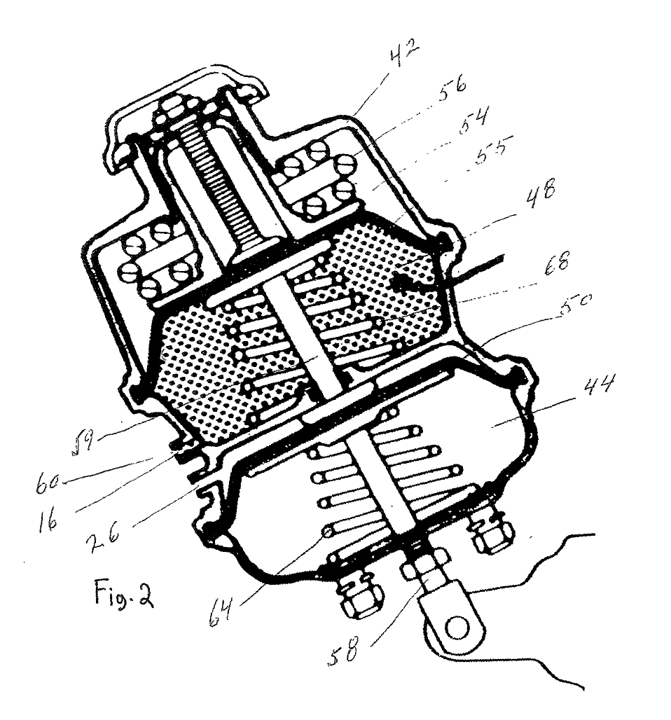

Referring now to FIG. 2, when air pressure is applied via pressure line 16, chamber 48 is pressurized and diaphragm 55 is moved into its inflated position which forces the compression of spring 56. Chamber 44 houses compression spring 64 and chamber 48 houses spring 68. When compression spring 56 is compressed, springs 64 and 68 are free to move rod 58 back into housing 42 causing the trailer brake to disengage. During normal operation the trailer brake is not engaged and spring brake 40 is in its running position as shown in FIG. 2, with spring 56 compressed, chamber 48 inflated and springs 64 and 68 substantially relaxed.

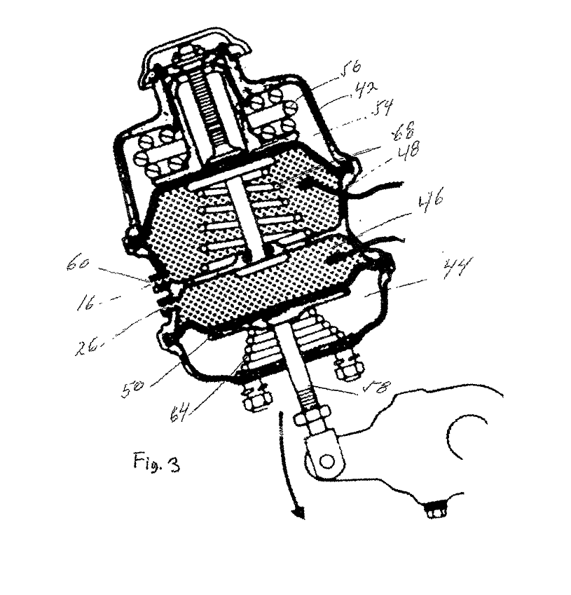

Referring now to FIG. 3, when the vehicle operator wishes to apply the brakes, he or she causes air pressure to be sent down air line 26 causing chamber 46 to pressurize. Pressurizing chamber 46 causes diaphragm 50 to move, which in turn causes compression of spring 64, the outward movement of rod 58 and the engaging of the trailer brake. Therefore, when the operator engages the brakes during normal operation, both chambers 48 and 46 are pressurized and compression spring 56 is compressed.

Referring back to FIG. 2, if chamber 48 were to become depressurized during normal operation, diaphragm 55 could no longer compress spring 56. During normal operation, the pressure in air chamber 48 is between 100 to 120 psi, which is sufficient to compress spring 56. However, if the pressure in chamber 48 drops to 60 psi, compression spring 56 will force the downward movement of diaphragm 55 causing springs 68 and 64 to compress, rod 58 to extend and, therefore, the trailer brake to engage. Hence, a sudden pressure drop in chamber 48 during normal operation will cause an almost immediate application of the trailer brakes. The present invention achieves this nearly immediate brake application by providing an electrically operated exhaust valve adjacent port 60.

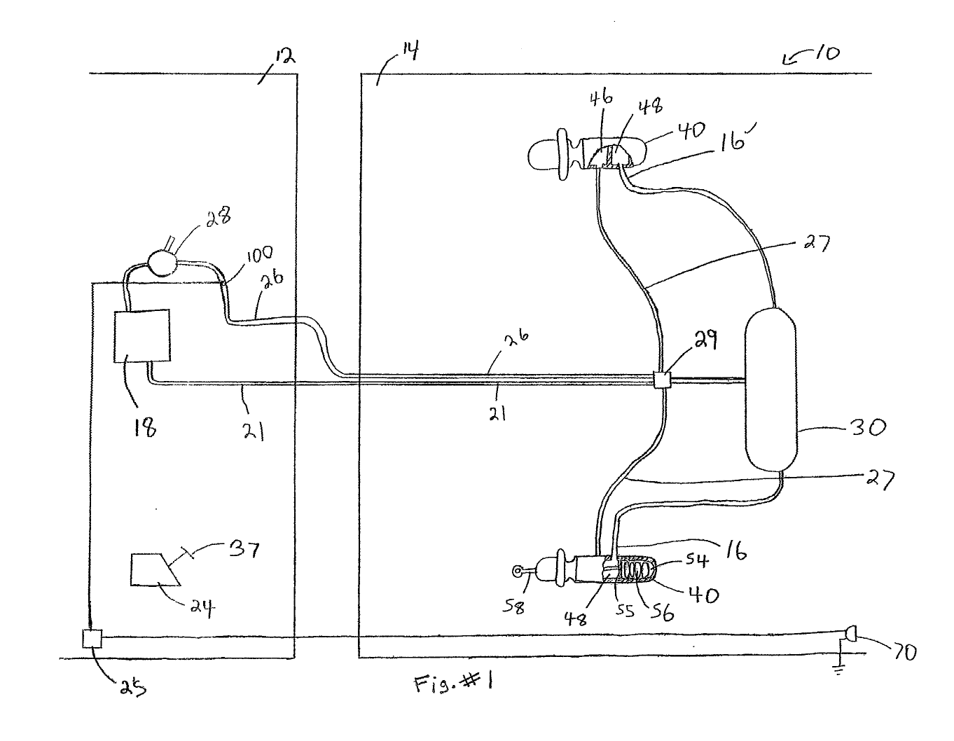

Referring now to FIG. 1, during normal operation of the tractor trailer, air chambers 48 of spring brakes 40 are pressurized by pressure supply line 16 which are fed from pressure reserve tank 30. With air chamber 48 pressurized, the spring brake is released. When the operator wishes to slow down, he or she may depress foot pedal 37 to engage brake mechanism 24 which is in turn operatively coupled to air supply 18. When air supply 18 is operated by brake mechanism 24, air supply 18 increases the air pressure in pressure line 26. Pressure line 26 is connected to pneumatically controlled brake valve 29, which is coupled to pressure reserve tank 30 and pressure lines 27 and 21. When the air pressure in line 26 increases, pneumatically controlled valve 29 sends air pressure from pressure tank 30 to line 27 through valve 29, which in turn pressurizes air chamber 46, which then causes the trailer brake to engage. In most cases, however, the vehicle operator chooses to slow the vehicle down by operating hand valve 28. When hand valve 28 is turned, the air pressure in line 26 is likewise increased and air chamber 46 is pressurized. Engaging the trailer brake by pressurizing air chamber 46 takes a surprisingly long time, often as much as one to two seconds. Hence, in a conventional air brake assembly, it can take as long as two seconds for the trailer brakes to engage after the operator engages the brake controls (for example, turning hand valve 28).

The present invention comprises a solenoid exhaust valve operatively coupled to a standard spring brake and controlled by a solenoid control circuit. The solenoid exhaust valve and control circuit are configured to exhaust air chamber 48 almost immediately upon the driver engaging the brake controls. In effect, the system permits the nearly instantaneous application of the trailer brakes when the brake controls are engaged by the driver. The improved brake system consists of spring brakes 40, air supply system 18, first (supply) air line 20, solenoid exhaust valve 22, air line 16, brake hand valve 28 and solenoid control system 25. Solenoid exhaust valves 22 are operatively coupled to hand valve 28 via solenoid control circuit 25 such that when hand valve 28 is engaged during an emergency, solenoid exhaust valves 22 operates to momentarily decompress chamber 48 of spring brakes 40, causing the immediate engaging of the trailer brakes. Solenoid control circuit 25 operates solenoid exhaust valve 22 such that after approximately one second, the exhaust valve stops exhausting air chamber 48.

Solenoid exhaust valve 22 preferably comprises a three way solenoid valve which is normally open. The solenoid valve will be coupled to air line 20 which receives pressurized air, and air line 16, which sends the pressurized air to air chamber 48 of spring brake 40. Solenoid valve 22 will have two states, namely an open state, wherein the solenoid valve permits air to flow through supply lines 20 and 16, and an exhaust state, wherein the solenoid valve blocks air line 20 and exhausts air chamber 48 of spring brake 40 through supply line 16. When solenoid exhaust valve 22 is in its exhaust state, air line 16 is open to atmospheric pressure, causing an almost instantaneous drop in the air pressure within air chamber 48 of spring brake 40. Solenoid valve 22 is preferably a normally open valve, meaning that the valve is ordinarily in its open state until energized, at which point it will enter its exhaust state. In the event the electrical system of the tractor trailer is interrupted, solenoid valve 22 will remain in its open state. This is an important safety feature preventing the accidental engagement of the trailer brakes during an electrical failure.

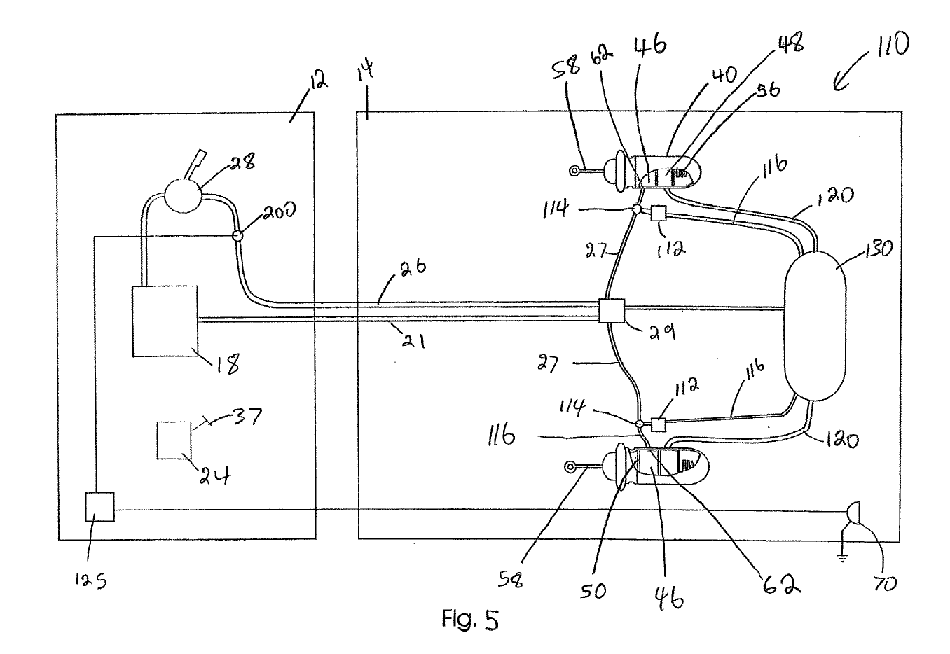

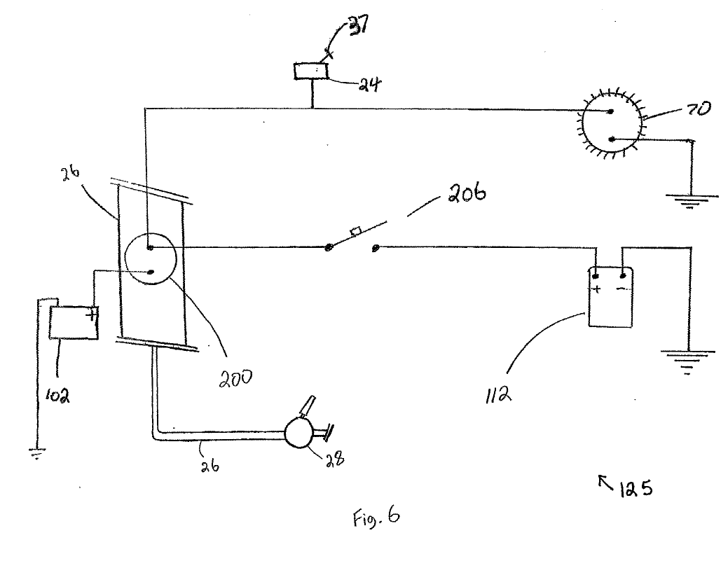

Referring now to FIGS. 5 and 6, while several suitable three way solenoid valves are available on the market, one particular embodiment of the solenoid valve of the present invention is shown. Solenoid exhaust valve 22 has a valve portion 80 and a solenoid portion 82. Valve portion 80 consists of a housing 81 which houses piston 84. Piston 84 has a first air passage 86 and a second (exhaust) air passage 88. Exhaust passage 88 is opened to relief port 90 in housing 81, which in turn is open to atmospheric pressure. Housing 81 has exhaust port 92 which is connected to air supply line 16 which is in turn coupled to the spring brake as previously discussed. Housing 81 also has intake port 94 which is connected to air supply line 20. Housing 81 has piston chamber 96 which is dimensioned and configured to permit piston 84 to move between an exhaust position, as shown in FIG. 5, wherein exhaust port 92 is aligned with air passage 88, and an open position, as shown in FIG. 6, wherein air passage 86 couples ports 92 and 94, which in turn couples air lines 16 and 20. Solenoid portion 82 controls the movement of piston 84. When portion 82 forces piston 84 into its exhaust position, solenoid exhaust valve 22 is in its exhaust state and air passage 88 is aligned with port 92 causing the depressurizing of the spring brake. Piston wall 85 blocks port 94 causing air supply 20 to be decoupled from the spring brake when the solenoid valve is in its exhaust state. Since air passage 88 is open to atmospheric pressure, the spring brake is rapidly depressurized. When solenoid portion 82 moves piston 84 into its open position, air passageway 86 is aligned with ports 94 and 92, permitting the spring brake to be pressurized by air supply line 20.

Referring to FIG. 7, the operation of solenoid control circuit 25 shall now be discussed. Solenoid control circuit 25 consists of pneumatic pressure sensor 100, battery 102, circuit breaker 104, solenoid switch 106, and brake light 108 all of which are operatively coupled to solenoid portion 82 of solenoid control valve 22. Pressure sensor 100 is in direct pressure contact with air line 26, such that the pressure sensor closes circuit 25 when the air pressure in air line 26 increases. Circuit breaker 104 is a momentary circuit breaker which is normally closed, but which opens circuit 25 after approximately one second. Circuit breaker 104 resets itself after approximately three seconds; therefore, when current is applied to breaker 104, the breaker will open the circuit after one second, then close the circuit after three seconds, then open the circuit again after one second, and so on. Therefore, when sensor 100 closes circuit 25, circuit breaker 104 will send a series of energizing pulses to the solenoid valve, the pulses being one second long and three seconds apart. Solenoid switch 106 provides current to brake light 108 when pressure sensor 100 is closed, causing the break light to light up. Solenoid switch 106 serves to electrically isolate circuit 25 from foot break control mechanism 24; therefore, brake light 108 can be immediately turned on when foot break pedal 37 is depressed, without energizing exhaust valve 22.

The operation of the entire system will now be discussed with reference to FIG. 1. When an emergency situation occurs, hand valve 28 is turned by the vehicle operator and the pressure in line 26 increases. Pressure line 26 is operatively coupled to control circuit 25 such that increasing the pressure in line 26 causes solenoid control circuit 25 to energize solenoid exhaust valve 22. Therefore, when hand valve 28 is engaged, solenoid control circuit 25 causes solenoid exhaust valves 22 to lower the air pressure in air chambers 48 of spring breaks 40, which in turn causes an almost immediate application of a limited amount of breaking pressure to the trailer brakes. Trailer portion 14 of the vehicle then begins to slow down and a jack-knife is avoided. Simultaneously, the higher air pressure in line 26 eventually causes pneumatic control valve 29 to operate and pressurize air chambers 46, which eventually causes more brake pressure to be applied to the trailer brakes. Since circuit 25 only energizes solenoid exhaust valve 22 for about one second, air chamber 48 begins to be recharged with air pressure after air chamber 46 is sufficiently pressurized to permit spring brake 40 to engage the trailer brakes. Circuit 25 keeps solenoid exhaust valve 22 open for three seconds, which is generally sufficient to fully pressurize air chamber 48. For many cases, the emergency situation will be over by the time air chamber 48 is re-pressurized, at which point spring 56 will be fully compressed. The driver can then drive the vehicle normally. In the event solenoid exhaust valve 22 fails and remains jammed in the exhaust position, then spring brake 40 will continue to engage the trailer brake. Fortunately, a majority of trailers on the road today are provided with a buzzer system (not shown) which sound a buzzer alarm in truck 12 when the pressure within air chamber 48 drops below a preset lower limit.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A system for immediately engaging a trailer brake of a tractor trailer when a brake control member in the tractor is engaged by a driver, the trailer brake being operatively coupled to an air brake having a first spring operatively coupled to the trailer brake, the first spring engaging the trailer brake when the spring is in a relaxed position, a first pneumatic chamber having a first movable diaphragm, the movable diaphragm causing the first spring to compress and disengage the trailer brake when the first chamber is compressed with air supplied by an air line, decompression of the first pneumatic chamber permitting the first spring to relax and engage the trailer brake, the system comprising:
(a) an electrically operated exhaust valve mounted adjacent the air brake and operatively coupled to the first pneumatic chamber, the electrically operated exhaust valve having an exhaust state wherein the valve exhausts the first pneumatic chamber and an open state wherein the valve does not exhaust the first pneumatic chamber,
(b) a control circuit operatively coupled to the exhaust valve and to the brake control member, the control circuit configured to energize the exhaust valve when the brake control member is engaged.

2. A brake system as defined in claim 1 wherein the control circuit energizes the electrically operated exhaust valve for a first time interval, the first time interval being selected to permit the first pneumatic chamber to depressurize sufficiently to permit the first spring to engage the trailer brake, the control circuit further adapted to de-energize the electrically operated exhaust valve at the end of the first time period.

3. A brake system as defined in claim 2 wherein the first time interval is approximately one second.

4. A brake system as defined in claim 2 wherein the control circuit is further adapted to permit the control circuit to again energize the electrically operated exhaust valve after the expiration of a second time period, said second time period being sufficiently long to permit the first pneumatic chamber to be substantially re-pressurized to disengage the trailer brake.

5. A brake system as defined in claim 2 wherein the control circuit includes a circuit breaker, the circuit breaker adapted to de-energize the electrically operated exhaust valve after the first time period.

6. A brake system as defined in claim 1 wherein the electrically operated exhaust valve operatively couples the first pneumatic chamber to the pressure line.

7. A brake system as defined in claim 6 wherein the electrically operated exhaust valve comprises a three way valve having a normally open state wherein the valve pneumatically couples the pressure line to the first pneumatic chamber, and an exhaust state, wherein the valve decouples the first pneumatic chamber from the pressure line and the valve exhausts the pneumatic chamber.

8. A brake system as defined in claim 7 wherein the electrically operated exhaust valve comprises a normally open three way servo valve.
